(19) United States
(12) Patent Application Publication
(10) Pub. No.: US 2025/0335276 A1
(43) Pub. Date: Oct. 30, 2025

(54) CONTEXT BASED HEALTH VISUALIZATION SYSTEM AND METHOD FOR A COMPUTING ENVIRONMENT

(71) Applicant: Dell Products L.P., Round Rock, TX (US)

(72) Inventors: Barbara Ballard, Needham, MA (US); Ming Qian, Brighton, MA (US); Robert Barrett, Austin, TX (US); Yihan Lin, Kirkland, WA (US); Erick Oldan, Richmond, CA (US); Caleb George, Naples, ME (US)

(73) Assignee: Dell Products L.P., Round Rock, TX (US)

(21) Appl. No.: 18/650,184

(22) Filed: Apr. 30, 2024

(51) Int. Cl. G06F 11/00

(52) U.S. Cl. CPC G06F 11/008; G06F 2201/86

(57) ABSTRACT

Embodiments of the present disclosure provide a context based health visualization system and method for a computing environment that indicates context-based health information for the computing resources of a computing environment. According to one embodiment, an Information Handling System (IHS) includes computer-executable instructions to identify a maintenance task that needs to be performed on a computing resource, classify the maintenance task according to one of a plurality of health contexts, and generate, using information associated with the maintenance task, a health context score for the one health context. The maintenance task may be one that impacts an overall health score of the computing resource. The instructions may then cause the IHS to display the health context score for view by a user.

### BACKGROUND

As the value and use of information continues to increase, individuals and businesses seek additional ways to process and store information. One option is an Information Handling System (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware, and software components that may be configured to process, store, and communicate information and may include one or more computer systems, data storage systems, and networking systems.

Modern day computing resources are provided by large computing environments that may include server farms, computer clusters, individual computing devices, and/or data centers. Computing environments are generally associated with large organizations, such as business enterprises to educational institutions such as universities. In many cases, larger organizations may manage multiple server farms over a diverse geographical region. Nevertheless, management of such large, diversified computing environments can, and often does, involve a myriad of complexities. As such, health scores for the computing resources in a computing environment have been established in order to provide administrators with a tool for monitoring large computing environments. The health score generally refers to a metric value (e.g., 0 to 100) assigned to a computing resource that indicates its overall robustness. The health status of a computing resource, nevertheless, can change quickly. A high health score of a computing resource generally indicates that the computing resource is functioning well, while a low health score may indicate that something is wrong with it, such as when it is running outdated software, or a component has failed.

### SUMMARY

Embodiments of the present disclosure provide a context based health visualization system and method for a computing environment that indicates context-based health information for the computing resources of a computing environment. According to one embodiment, an Information Handling System (IHS) includes computer-executable instructions to identify a maintenance task that needs to be performed on a computing resource, classify the maintenance task according to one of a plurality of health contexts, and generate, using information associated with the maintenance task, a health context score for the one health context. The maintenance task may be one that impacts an overall health score of the computing resource. The instructions may then cause the IHS to display the health context score for view by a user.

According to another embodiment a context based health visualization method includes the steps of identifying a maintenance task that needs to be performed on a computing resource, wherein the maintenance task impacts an overall health score of a computing resource, classifying the maintenance task according to one of a plurality of health contexts, generating, using information associated with the maintenance task, a health context score for the one health context, and displaying the health context score for view by a user.

According to yet another embodiment, a computer program product includes a non-transitory computer readable storage medium with program instructions to identify a maintenance task that needs to be performed on a computing resource, wherein the maintenance task impacts an overall health score of the computing resource, classify the maintenance task according to one of a plurality of health contexts. generate, using information associated with the maintenance task, a health context score for the one health context, and display the health context score for view by a user.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 is a block diagram of examples of components of an Information Handling System (IHS) that may be used to implement a context based health monitoring system and method according to one embodiment of the present disclosure.

FIG. 2 illustrates an example context based health visualization system that may be implemented in a computing environment according to one embodiment of the present disclosure.

FIG. 3 is a diagram view illustrating several components of the example context based health visualization system according to one embodiment of the present disclosure.

FIG. 4 illustrates an example server screen view that may be generated by the systems manager for providing a context based health visualization system and method according to one embodiment of the present disclosure.

FIGS. 5A-F illustrate several example enhanced health score indication icons that may be generated by the systems manager to indicate enhanced health scores according to one embodiment of the present disclosure.

FIG. 6 illustrates an example detailed health monitoring screen that may be generated by the systems manager according to one embodiment of the present disclosure.

FIG. 7 is a flowchart describing certain steps of one embodiment of a context based health visualization method using the systems manager according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Management of a large, diversified computing environment is typically provided by a remotely configured system management console. Openmanage Enterprise is one example of a system management console provided by Dell Technologies, which cost-effectively facilitates comprehensive lifecycle management for the computing devices of distributed computing environments from one console.

Health is an indicative universal approach to providing the status and performance of a computing resource. The conventional approach within existing administrative systems has been to assign a metric value within a range (e.g., 0 to 100) to a computing resource and/or use a category indicator of green, yellow, red to encompass all possible scores within the entire range. However, the metric value range and color coding is linear in that it does not indicate the in-depth context and detailed information behind the health score. For instance, when a particular computing resource has a score of 75 and is in the orange color, it often does not indicate anything other than that the health status is not too bad, but also not too good. It also may not provide any additional key information for troubleshooting, such as the short-term risk, long-term risk, and/or opportunities to improve. Research by the inventors in the present case has shown that users (e.g., computing environment administrators) understanding of health is dimensional and it should convey at least three key aspects (e.g., an immediate aspect, an upcoming aspect, and an efficiency aspect) to aid the user with understanding the overall health of a computing resource. In general, the immediate aspect refers to maintenance tasks that should be performed immediately, the upcoming aspect refers to maintenance tasks that should be performed in the near future, while the efficiency aspect refers to maintenance tasks that should be performed to enhance the performance of the computing resource.

Conventional monitoring and health score visual tools, however, do not convey such aspects. This lack of context could cause a misunderstanding of what is actually needed to be resolved and the real contextual urgency of the health status. This could eventually slow down the problem-solving process when troubleshooting specific incidents and cause more severe issues to the computing environment as well as to a business/organization/enterprise that uses it. As will be described in detail herein below, embodiments of the present disclosure provide a context based health visualization system and method for a computing environment that indicates not only a linear health score, but also indicates timeliness factors (e.g., immediate, upcoming aspects) as to how maintenance tasks should be scheduled, and performance enhancing factors (e.g., efficiencies) associated with certain tasks that should be performed to enhance the performance of each of multiple computing resources. The context based health visualization system and method generally involves a new visual design that provides users with direct and holistic contextual information about the overall health status of computing resources in addition to a visualization technique that combines color-coded indicators as well as a volumetric representation of the health score for the computing resource.

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory.

Additional components of an IHS may include one or more disk drives, one or more network ports for communicating with external devices as well as various I/O devices, such as a keyboard, a mouse, touchscreen, and/or a video display. As described, an IHS may also include one or more buses operable to transmit communications between the various hardware components. An example of an IHS is described in more detail below.

The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, touchscreen and/or a video display. The IHS may also include one or more buses operable to transmit communications between the various hardware components.

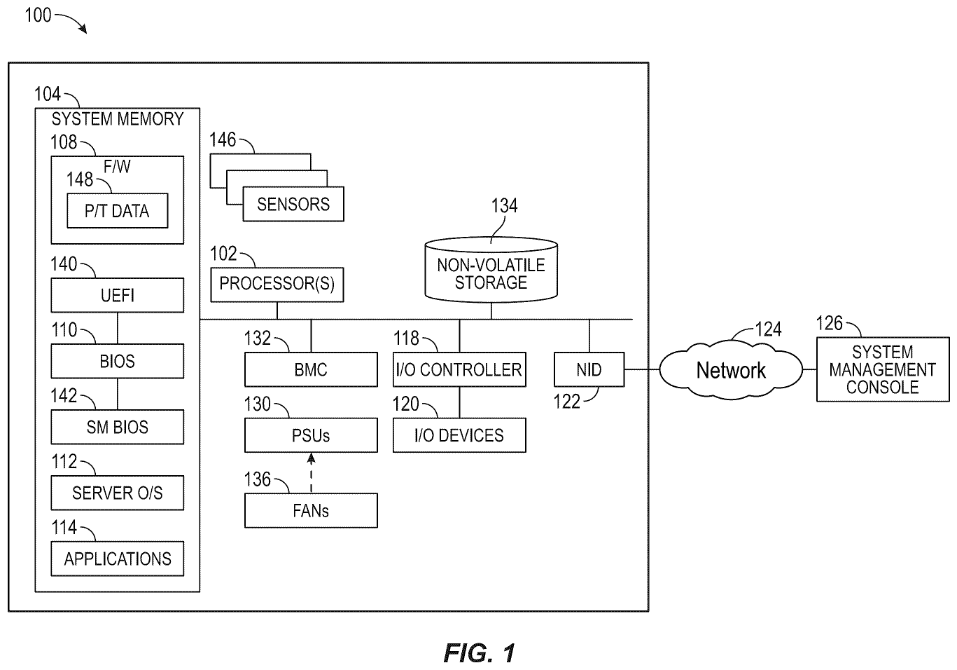

FIG. 1 is a block diagram of examples of components of an Information Handling System (IHS) that may be used to implement a context based health monitoring system and method according to one embodiment of the present disclosure. Particularly, IHS 100 includes one or more processor(s) 102 coupled to system memory 104 via system interconnect 106. System interconnect 106 may include any suitable system bus. System memory 104 may include a plurality of software and/or firmware modules including firmware (F/W) 108, basic input/output system (BIOS) 110, operating system (O/S) 112, and/or application(s) 114. Software and/or firmware module(s) stored within system memory 104 may be loaded into processor(s) 102 and executed during operation of IHS 100.

F/W 108 may include a power/thermal profile data table 148 that is used to store power profile data and thermal profile data for certain hardware devices (e.g., processor(s) 102, system memory 104, non-volatile storage 134, NID 122, I/O controllers 118, etc.). System memory 104 may include a UEFI interface 140 and/or a SMBIOS interface 142 for accessing the BIOS as well as updating BIOS 110. In general, UEFI interface 140 provides a software interface between an operating system and BIOS 110. In many cases, UEFI interface 140 can support remote diagnostics and repair of computers, even with no operating system installed. SMBIOS interface 142 can be used to read management information produced by BIOS 110 of an IHS 100. This feature can eliminate the need for the operating system to probe hardware directly to discover what devices are present in the computer.

IHS 100 includes one or more input/output (I/O) controllers 118 which manages the operation of one or more connected input/output (I/O) device(s) 120, such as a keyboard, mouse, touch screen, microphone, a monitor or display device, a camera, a microphone, audio speaker(s) (not shown), an optical reader, a universal serial bus (USB), a card reader, Personal Computer Memory Card International Association (PCMCIA) slot, and/or a high-definition multimedia interface (HDMI), which may be included or coupled to IHS 100.

IHS 100 includes Network Interface Device (NID) 122. NID 122 enables IHS 100 to communicate and/or interface with other devices, services, and components that are located externally to IHS 100. These devices, services, and components, such as a system management console 126, can interface with IHS 100 via an external network, such as network 124, which may include a local area network, wide area network, personal area network, the Internet, etc.

For the purposes of this disclosure, the term “system management console” may refer broadly to systems that are configured to couple to a management controller and issue management instructions for an information handling system (e.g., computing device) that is being managed by the management controller. One example of such a system management console is the Dell OpenManage Enterprise (OME) systems management console. In various embodiments, management consoles may be implemented via specialized hardware and/or via software running on a standard information handling system. In one embodiment, a system management console may be deployed on a secure virtual machine (VM), such as a VMWARE Workstation appliance.

IHS 100 further includes one or more power supply units (PSUs) 130. PSUs 130 are coupled to a BMC 132 via an I²C bus. BMC 132 enables remote operation control of PSUs 130 and other components within IHS 100. PSUs 130 power the hardware devices of IHS 100 (e.g., processor(s) 102, system memory 104, non-volatile storage 134, NID 122, I/O controllers 118, etc.). To assist with maintaining temperatures within specifications, an active cooling system, such as one or more fans 136 may be utilized.

IHS 100 further includes one or more sensors 146. Sensors 146 may, for instance, include a thermal sensor that is in thermal communication with certain hardware devices that generate relatively large amounts of heat, such as processors 102 or PSUs 130. Sensors 146 may also include voltage sensors that communicate signals to BMC 132 associated with, for example, an electrical voltage or current at an input line of PSU 130, and/or an electrical voltage or current at an output line of PSU 130.

BMC 132 may be configured to provide out-of-band management facilities for IHS 100. Management operations may be performed by BMC 132 even if IHS 100 is powered off, or powered down to a standby state. BMC 132 may include a processor, memory, and an out-of-band network interface separate from and physically isolated from an in-band network interface of IHS 100, and/or other embedded resources.

In certain embodiments, BMC 132 may include or may be part of a Remote Access Controller (e.g., a DELL Remote Access Controller (DRAC) or an Integrated DRAC (IDRAC)). In other embodiments, BMC 132 may include or may be an integral part of a Chassis Management Controller (CMC).

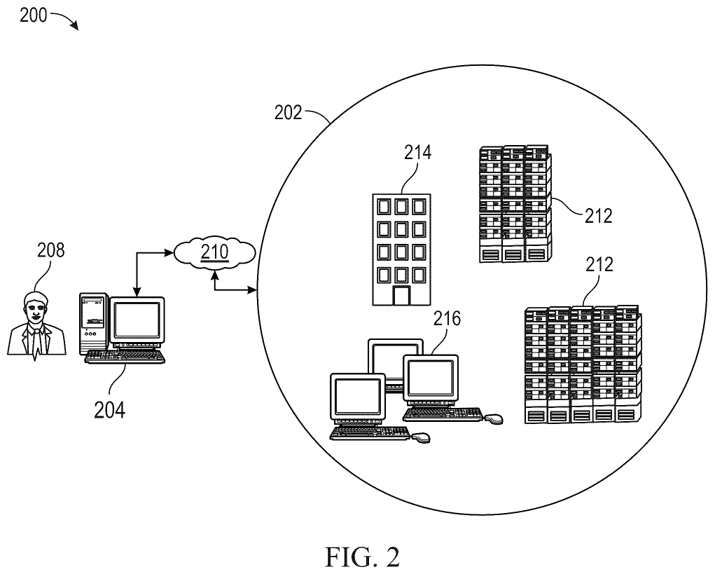

FIG. 2 illustrates an example context based health visualization system 200 that may be implemented in a computing environment according to one embodiment of the present disclosure. The context based health visualization system 200 generally includes a computing environment 202 that is managed by a systems management appliance 204. As shown, the systems management appliance 204 communicates with the computing environment 202 through a network 210. Nevertheless, it should be appreciated that the systems management appliance 204 may communicate locally with the computing environment 202, or form a part of the computing environment 202.

In general, the systems management appliance 204 is configured to monitor and control any number of computing resources in the computing environment 202. While the present disclosure describes the example context based health visualization system 200 as being directed to computing resources, it should be understood that the example context based health visualization system 200 may be used with any suitable type of resources, such as networking resources, and/or storage resources. In one embodiment, the systems management appliance 204 provides at least a portion of the features of the systems management console 126 described herein above. The computing environment 202 may include any type and quantity of computing resources, such as those that may be included in a computing cluster 212, a data center 214, or multiple computing devices 216 of an organizational entity, such as a business, or school. In a particular example, computing environment 202 may be one managed by a single entity, such as a vendor of the computing devices, or some other large organization having a first computing cluster 212 located in Dallas, Texas, a second computing cluster 212 located in Houston, Texas, a data center 214 located in Atlanta, Georgia, and multiple computing devices 216 located in their home office in Austin, Texas. Thus, the number and type of computing resources managed by the systems management appliance 204 can, and often does, vary widely across the computing environment that it is designed to manage.

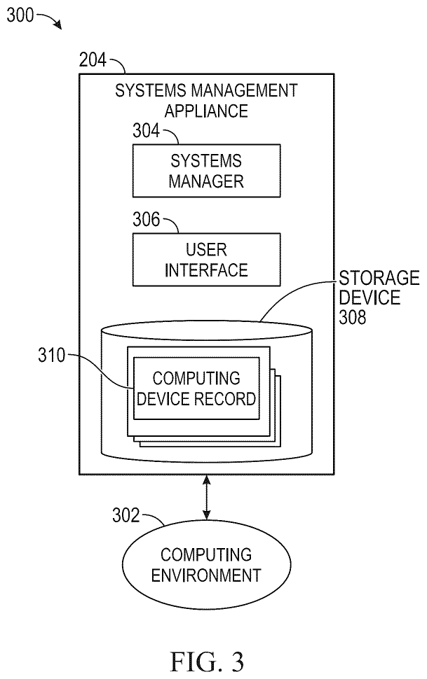

FIG. 3 is a diagram view illustrating several components of the example context based health visualization system 300 according to one embodiment of the present disclosure. The context based health visualization system 300 includes a systems management appliance 204 installed with a systems manager 304, a user interface 306, and a storage device 308. In one embodiment, the user interface 306 provides at least a portion of the features of the systems management console 126 described herein above. The systems manager 304 monitors and controls the operation of various computing devices as described above with reference to FIG. 2. In one embodiment, systems manager 304 includes at least a portion of the Dell EMC OpenManage Enterprise (OME) that is installed on a secure virtual machine (VM), such as a VMWARE Workstation. Storage device 308 stores computing device records 310 each associated with a computing device in the computing environment 302. Each computing device record 310 includes information about its associated computing device in the computing environment 302.

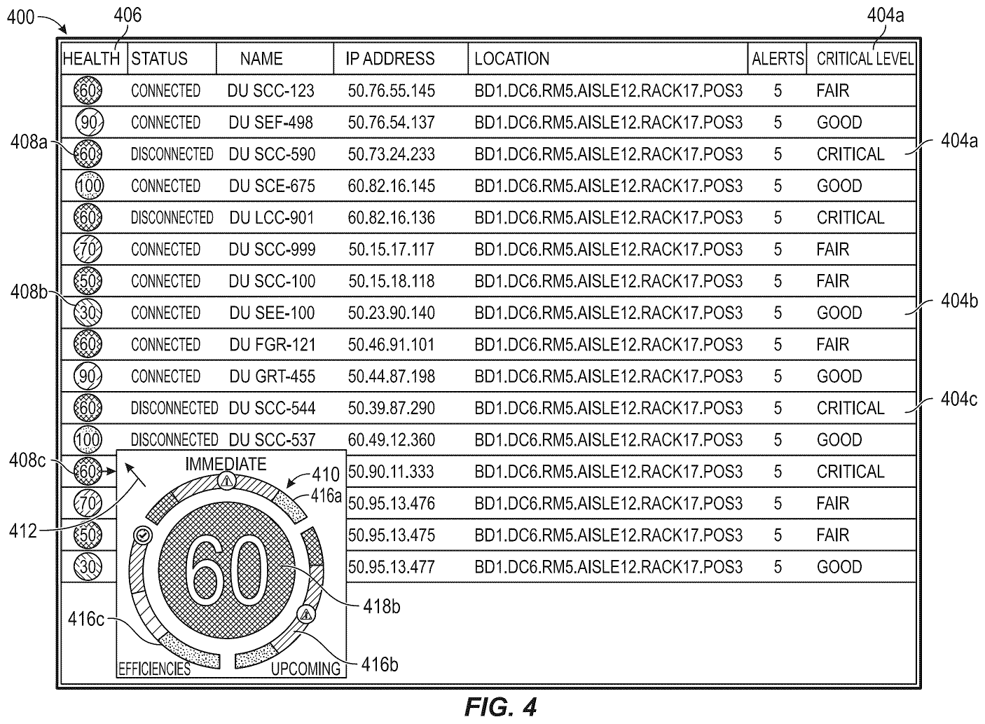

FIG. 4 illustrates an example server screen view 400 that may be generated by the systems manager 304 for providing a context based health visualization system and method according to one embodiment of the present disclosure. The server screen view 400 displays a table with multiples rows 404a-c (collectively 404) each corresponding to a server that is monitored and managed by the systems manager 304. For example, row 404a corresponds to a server with name ‘DU SEF-498’, row 404b corresponds to a server with the name ‘DU DEE-100’, while row 404c corresponds to a server with the name ‘DU SCC-544.’ The servers may be, for example, configured in either of computing cluster 212, a data center 214, or multiple computing devices 216 of the computing environment 202 as described above with reference to FIG. 2. Additionally, while the server screen view 400 is described as being directed to health monitoring of servers, it should be appreciated that embodiments of the present disclosure may be directed to monitoring the health of any type of computing resource, such as IHSs, hard disk drives, computing clusters, network switches, and the like.

The table 402 also includes a column 406 that displays a health score 408a-c (collectively 408) that has been calculated for the server associated with each respective row 404. For example, the server associated with row 404a is assigned with a health score 408a of ‘60,’ the server associated with row 404b is assigned with a health score 408b of ‘30,’ and the server associated with row 404c is assigned with a health score 408c of ‘60.’

According to embodiments of the present disclosure, the systems manager 304 may display an enhanced health score indication icon 410 that indicates additional aspects or contexts that have affected the overall metric value health score that is assigned to each server. In one embodiment, the enhanced health score indication icon 410 may be displayed whenever a mouse pointer 412 is hovered over a particular row 404 representing a particular server. As shown in the example server screen view 400 for example, the enhanced health score indication icon 410 is displayed for the server represented in row 404c because the mouse pointer 412 is hovering over row 404c. Such a behavior may be particularly useful due to the fact that the enhanced health score indication icon 410 may remain hidden from view to not unnecessarily clutter the screen until the user is interested in addressing the server by viewing the additional health information provided by the enhanced health score indication icon 410 in some embodiments.

The enhanced health score indication icon 410 indicates additional information about certain health contexts using indicators 416a-c (collectively 416) using an immediate context indicator 416a, an upcoming context indicator 416b, and an efficiencies context indicator 416c that are each used to derive the overall health score 418 for each server that is monitored and managed by the systems manager 304. The immediate context indicator 416a generally refers to any maintenance tasks that should be performed immediately in order to raise the overall health score for the server. A failed expansion card (e.g., I/O card, NIC card, etc.), for example, which should be replaced immediately, may be represented by the immediate context indicator 416a. The upcoming context indicator 416b refers to certain maintenance tasks that should be performed in the near future (e.g., one week, one month, etc.). An example of an upcoming context may be a security certificate that is expected to expire within the upcoming month. The efficiencies context indicator 416c refers to certain tasks that should be performed to improve the performance of the server. Examples of efficiency-based tasks may include adjusting a load balancing of network ports or improving power budgeting for the power supplies in the server.

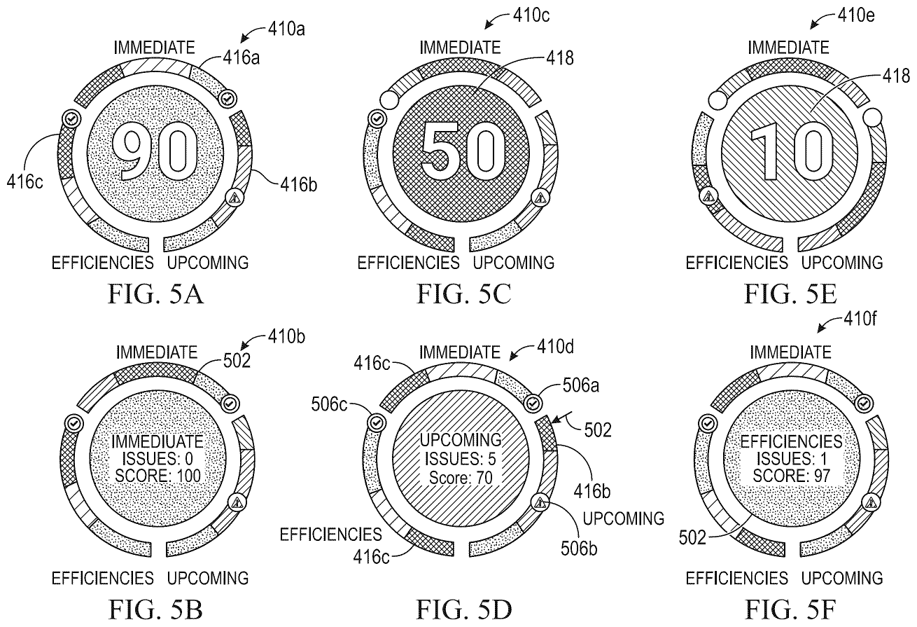

FIGS. 5A-F illustrate several example enhanced health score indication icons 410a-f (collectively 410) that may be generated by the systems manager 304 to indicate enhanced health scores according to one embodiment of the present disclosure. As shown in FIG. 5A, each enhanced health score indication icon 410 may show the overall health score 418 of a server on a scale of 0 to 100 to indicate the degree to which the object is meeting its service level agreement (SLA). That is, an overall health score of ‘100’ may indicate that the computing resource is optimally meeting its SLA and may be generated with a green color, while an overall health score of ‘0’ may indicate that its respective server is not meeting its SLA and may be generated with a red color. In one embodiment, orange may be used to denote a minor problem with the health score, while red may be used to denote a critical problem with the computing resource.

For example, FIG. 5A illustrates an enhanced health score indication icon 410a that may be generated for a server with an overall health score of ‘90’, FIG. 5C illustrates an enhanced health score indication icon 410c that may be generated for a server with an overall health score of ‘50’, while FIG. 5E illustrates an enhanced health score indication icon 410e that may be generated for a server with an overall health score of ‘10’.

The immediate context indicator 416a, upcoming context indicator 416b, and efficiencies context indicator 416c are displayed as a ring around the overall health score 418. When a mouse pointer 502 is hovered over the immediate context indicator 416a, the systems manager 304 may display certain details about the immediate context such as shown in FIG. 5B in which no immediate issues exist and the score for the immediate context is ‘100.’ For the enhanced health score indication icon 410 of FIG. 5C, when the mouse pointer 502 is hovered over the upcoming context indicator 416b, the systems manager 304 may display certain details about the upcoming context such as shown in FIG. 5D in which ‘5’ upcoming issues exist and the score for the upcoming context is ‘70.’ For the enhanced health score indication icon 410 of FIG. 5E, when the mouse pointer 502 is hovered over the efficiencies context indicator 416c, the systems manager 304 may display certain details about the efficiencies context such as shown in FIG. 5F in which ‘1’ efficiencies issues exist and the score for the efficiencies context is ‘97.’

In one embodiment, each context indicator 416 may be displayed in a Green-Yellow-Orange-Red color-coded system indicating for each context, its respective health level. As shown in FIG. 5A, for example, the immediate context indicator 416a and efficiencies context indicator 416c as shown mostly as green and yellow to indicate that these contexts are relatively good, while the upcoming context indicator 416b is shown as ranging from green to orange to indicate that certain upcoming contexts may exist with its respective server. To provide yet another example, as shown in FIG. 5C, the immediate context indicator 416a and upcoming context indicator 416b are shown mostly as red and yellow to indicate that these contexts are in need of maintenance, while the efficiencies context indicator 416c is shown as ranging from green to orange to indicate that its efficiencies context may be relatively healthy.

In one embodiment, each context indicator 416 may include a slider icon 506a-c (collectively 506) that provides additional visual information about each health context. In particular, the position of each slider icon 506 along the ring shape of its respective context indicator 416 may provide an overall value for the health of each context. As shown in FIG. 5D, for example, the mouse pointer 502 is hovered over the upcoming context indicator such that the slider icon 506b is positioned approximately halfway between the ends of the upcoming context indicator. Additionally, the shading or color may be re-produced in the center circularly-shaped icon showing that the upcoming context indicator 416b has ‘5’ issues, while having an overall score of ‘70’. To provide yet another example, the slider icon 506a, 506c associated with the immediate context indicator 416a and efficiencies context indicator 416c, respectively, are shown at their far clockwise end and is in the green shading to show that the immediate health context and efficiencies health context of its respective computing device are relatively good.

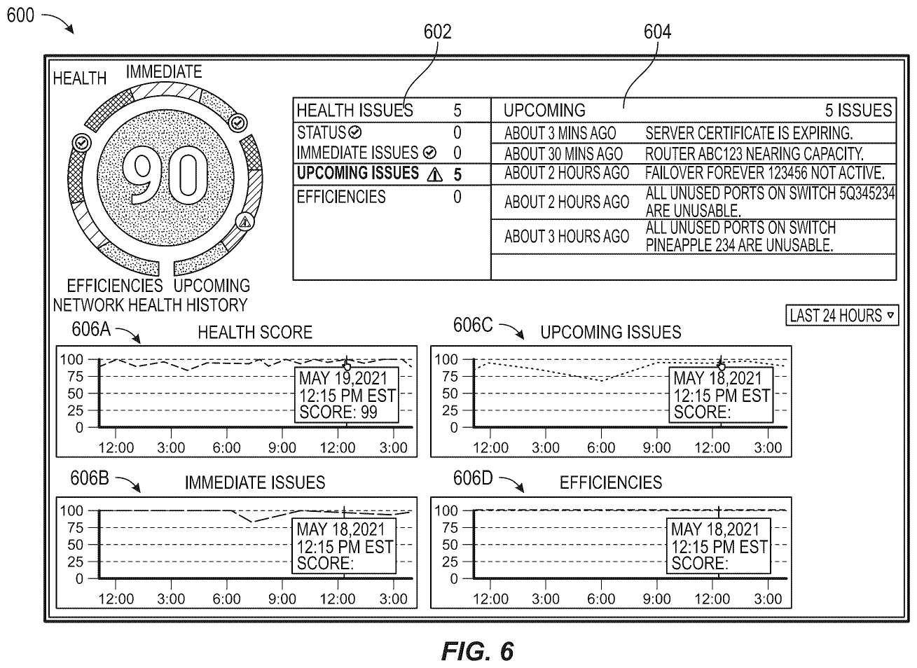

FIG. 6 illustrates an example detailed health monitoring screen 600 that may be generated by the systems manager 304 according to one embodiment of the present disclosure. The health monitoring screen 600 may be generated, for example, in response to a mouse click on one of the rows 404 of the server screen view 400 in order to reveal additional health-based information about the selected row's associated server. The health monitoring screen 600 includes an enhanced health score indication icon 410, a health issues summary table 602 that displays the contextual contexts of immediate issues, upcoming issues, and efficiency issues, and an upcoming health issues table 604. Within the table 604, each row in the table represents a unique upcoming issue ranked by timestamp. The health monitoring screen 600 also displays several graphs 606A-D (collectively 606) indicating historical health information about a sever. In particular, graph 606A displays a history of the overall health score of the server, graph 606B displays a history of the immediate issues that the server has experienced, graph 606C displays a history of the upcoming issues that the server has experienced, while graph 606D displays a history of the efficiency issues that the server has experienced. The graphs 606 may be particularly useful for identifying trends in the various contextual contexts for continual improvement in the health of the server over time according to some embodiments. While the health monitoring screen 600 is shown with tables 602, 604, and historical graphs 606, it should be appreciated that other embodiments may include additional information, less information, or other forms of information for monitoring the health of a server without departing from the scope of the present disclosure. Additionally, while the detailed health monitoring screen 600 is described above as representing the contextual health status of servers, it should be appreciated that the detailed health monitoring screen 600 may be used to show contextual health status for any type of resources, such as compute resources, networking resources, and/or storage resources.

Embodiments of the present disclosure may provide a new health visualization that reveals more contextual and holistic health status data around the performance of a specific object or a group of objects factoring in key data that are critical for gaining contexts and information prior to troubleshooting. Some key factors may include historical performance, volume of alerts, and established baselines to work from. By separating actionable tasks according to an immediate context, an upcoming context, and an efficiency context enables the system to provide a hierarchy of importance for personnel who maintain the servers in the computing environment 202. Thus, personnel can not only decide the priority level of immediate incidents but also be aware of the upcoming issues to reduce or prevent the long-term risk of any servers failing to meet their Service Level Agreement (SLA).

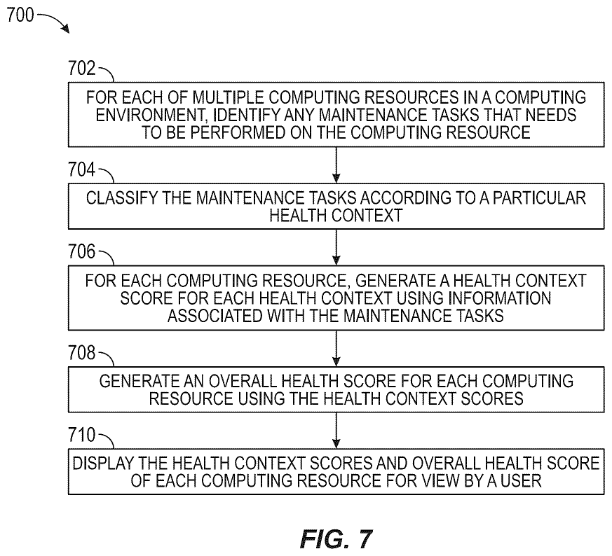

FIG. 7 is a flowchart describing certain steps of one embodiment of a context based health visualization method 700 according to one embodiment of the present disclosure. Additionally or alternatively, the context based health visualization method 700 may be performed by the systems manager 304 such as described above with reference to FIG. 3. In one embodiment, the context based health visualization method 700 may be performed any time that a user desires to view health scores for the computing resources of a computing environment. In another embodiment, the context based health visualization method 700 may be performed at ongoing intervals (e.g., periodically) in order to obtain and store historical health score information that can be displayed as graphs 606 for the user.

Initially at step 702, the context based health visualization method 700 identifies any maintenance tasks that needs to be performed on each of multiple computing resources in a computing environment 202. The maintenance tasks may be any type that impacts an overall health score of the computing resource. The systems manager 304 may identify any maintenance tasks by obtaining information (e.g., operational status, current processing load, etc.) about computing resource including information about any components in computing resource using a discovery process. For a particular example, the systems manager 304 may identify maintenance tasks by obtaining firmware version information from the computing resource including information about firmware version information from any components in computing resource and compare the firmware version information with known information about the latest firmware that should be on the computing resource to determine that a firmware update maintenance task should be performed.

At step 704, the context based health visualization method 700 classifies the maintenance tasks according to a particular health context. In one embodiment, the health context may include either an immediate health context in which the maintenance task should be performed immediately, an upcoming health context in which the maintenance task should be performed at least in the near future, and an efficiencies health context in which the maintenance task should be performed in order to improve the performance of the computing resource. The context based health visualization method 700 then generates a health context score for each health context using information associated with the maintenance tasks for each computing resource at step 706, and at step 708, generates an overall health score for each computing resource using the health context scores.

At step 710, the context based health visualization method 700 displays the health context scores and overall health score of each computing resource for view by a user. In one embodiment, only the overall health score of each computing resource may be displayed in order to conserve screen space on the display, and generate an enhanced health score indication icon 410 when the user desires to view additional information about a particular resource. In another embodiment, each context indicator 416 that displays health context information may be displayed in a green-yellow-orange-red color-coded system indicating for each health context, its respective health level. Nevertheless, when use of the context based health visualization method 700 is no longer needed or desired, the process ends.

Although FIG. 7 describes an example method that may be performed for generating and display context-based health information for view by a user, the features of the method 700 may be embodied in other specific forms without deviating from the spirit and scope of the present disclosure. For example, the method 700 may perform additional, fewer, or different operations than those described in the present example. As another example, the steps of the method 700 may be performed in a sequence different from that described herein above.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
at least one memory coupled to the at least one processor, the at least one memory having program instructions stored thereon that, upon execution by the at least one processor, cause the IHS to:
identify a maintenance task that needs to be performed on a computing resource, wherein the maintenance task impacts an overall health score of the computing resource;
classify the maintenance task according to one of a plurality of health contexts;
generate, using information associated with the maintenance task, a health context score for the one health context; and
display the health context score for view by a user.

2. The IHS of claim 1, wherein the instructions further cause the IHS to display each of the plurality of health context scores for view by a user.

3. The IHS of claim 2, wherein the instructions further cause the IHS to:
display an overall health score of each of a plurality of computing resources; and
display the health context scores when a mouse pointer is hovered over a field of a display representing the computing resource, wherein each of the health context scores comprises a slider icon that displays an overall health value for its respective health context.

4. The IHS of claim 2, wherein the instructions further cause the IHS to display a historical graph of the plurality of health context scores for view by the user.

5. The IHS of claim 2, wherein the instructions further cause the IHS to display each of the plurality of health context scores in a color-coded format.

6. The IHS of claim 1, wherein the health context comprises an immediate health context indicating that the maintenance task should be performed immediately.

7. The IHS of claim 1, wherein the health context comprises an upcoming health context indicating that the maintenance task should be performed in the future.

8. The IHS of claim 1, wherein the health context comprises an efficiencies health context indicating that the maintenance task should be performed to improve the performance of the computing resource.

9. The IHS of claim 1, wherein the instructions are performed by a systems manager that monitors and manages the operation of the computing resource.

10. A context based health visualization method comprising:
identifying a maintenance task that needs to be performed on a computing resource, wherein the maintenance task impacts an overall health score of a computing resource;
classifying the maintenance task according to one of a plurality of health contexts;
generating, using information associated with the maintenance task, a health context score for the one health context; and
displaying the health context score for view by a user.

11. The context based health visualization method of claim 10, further comprising displaying each of the plurality of health context scores for view by a user.

12. The context based health visualization method of claim 11, further comprising:
displaying an overall health score of each of a plurality of computing resources; and
displaying the health context scores when a mouse pointer is hovered over a field of a display representing the computing resource, wherein each of the health context scores comprises a slider icon that displays an overall health value for its respective health context.

13. The context based health visualization method of claim 11, further comprising displaying a historical graph of the plurality of health context scores for view by the user.

14. The context based health visualization method of claim 11, further comprising displaying each of the plurality of health context scores in a color-coded format.

15. The context based health visualization method of claim 10, wherein the health context comprises at least one of an immediate health context indicating that the maintenance task should be performed immediately, an upcoming health context indicating that the maintenance task should be performed in the future, or an efficiencies health context indicating that the maintenance task should be performed to improve the performance of the computing resource.

16. A computer program product comprising a non-transitory computer readable storage medium having program instructions embodied therewith, the program instructions executable by a processor to cause the processor to perform a method comprising:
identify a maintenance task that needs to be performed on a computing resource, wherein the maintenance task impacts an overall health score of the computing resource;
classify the maintenance task according to one of a plurality of health contexts;
generate, using information associated with the maintenance task, a health context score for the one health context;
display the health context score for view by a user.

17. The computer program product of claim 16, wherein the instructions further cause the processor to display each of the plurality of health context scores for view by a user.

18. The computer program product of claim 17, wherein the instructions further cause the processor to:
display an overall health score of each of a plurality of computing resources; and
display the health context scores when a mouse pointer is hovered over a field of a display representing the computing resource, wherein each of the health context scores comprises a slider icon that displays an overall health value for its respective health context.

19. The computer program product of claim 17, wherein the instructions further cause the processor to display a historical graph of the plurality of health context scores for view by the user.

20. The computer program product of claim 17, wherein the instructions further cause the processor to display each of the plurality of health context scores in a color-coded format.
